(19) United States
(12) Patent Application Publication
(10) Pub. No.: US 2019/0147493 A1
(43) Pub. Date: May 16, 2019

(54) Computer-Implemented System and Method for Transforming a Direct Mail Interaction between an Individual and an Advertiser

(71) Applicant: Textium LLC, St. Charles, MO (US)

(72) Inventors: Craig Schmitz, Weldon Springs, MO (US); William Haegele, Town & Country, MO (US); John Franco, Castle Rock, CO (US); Arthur DeLaurier, Naples, FL (US); Thomas Chernetsky, Suwanee, GA (US); Charles Byram, Suwanee, GA (US)

(21) Appl. No.: 16/020,342

(22) Filed: Jun. 27, 2018

Related U.S. Application Data
(60) Provisional application No. 62/585,618, filed on Nov. 14, 2017.

(51) Int. Cl. G06Q 30/02; G06F 17/30

(52) U.S. Cl. CPC G06Q 30/0267; G06Q 30/0269; G06F 17/30867

(57) ABSTRACT

Each of a set of direct mail pieces includes in its written content (i) a code identifying a corresponding one of the identified individuals, (ii) a text-to phone number configured to receive a text message from the corresponding individual, and (iii) an instruction to the corresponding individual to manifest interest in the content by sending, to the text-to phone number, a text message that includes the code. An intermediary server system stores the calling number of the mobile telephone number of the specific individual, retrieves, based on the received code, an advertiser message on behalf of the advertiser pertinent to the specific individual, and causes the advertiser message to be delivered to the mobile telephone of the individual by a mobile telephone carrier interface; and transmits, to a computer system of the specific advertiser, a sales lead message that includes the name and mobile telephone number of the specific individual.

### RELATED APPLICATIONS

The present application claims the benefit of U.S. provisional application Ser. No. 62/585,618, filed Nov. 14, 2017. That application is hereby incorporated herein by reference in its entirety.

### TECHNICAL FIELD

The present invention relates to direct mail programs and similar direct marketing programs, and more particularly to systems and methods for using direct mail programs and direct marketing programs for interactions between an individual and an advertiser.

### BACKGROUND ART

Direct mail programs (sometimes called “direct mail campaigns”), which involve delivery of direct mail pieces to individuals, are well known in the art. The selection of individuals to be targeted in a direct mail program is an area of frequent study. One system for selection is disclosed in U.S. Pat. No. 9,508,092.

### SUMMARY OF THE EMBODIMENTS

In accordance with one embodiment of the invention, there is provided a computer-implemented method for transforming a direct mail interaction between a specific individual and a specific advertiser, on the basis of a specific direct mail piece, having written content relating to an offering by the specific advertiser. In this embodiment, the specific piece is physically delivered to the specific individual, and the method utilizes computer processes, carried out by an intermediary server system. These computer processes include:

under conditions wherein the specific direct mail piece is one of a set of direct mail pieces targeted and physically delivered to identified individuals as part of a direct mail program by the specific advertiser, each direct mail piece including in its written content (i) a code identifying a corresponding one of the identified individuals, (ii) a text-to phone number configured to receive a text message from the corresponding individual, and (iii) an instruction to the corresponding individual to manifest interest in the content by sending, to the text-to phone number, a text message that includes the code:

responsive to receipt, at a mobile telephone carrier interface, of the corresponding text message, including the code, from a mobile telephone of the specific individual:
receiving, by the intermediary server system, coupled to the mobile telephone carrier interface, mobile phone data including the code and the calling number of a mobile telephone of the specific individual, wherein the intermediary server system is coupled to a direct mail program database system, the program database system storing record data, for each one of the identified individuals, including the specific individual, such individual's name, address, and code;
storing, by the intermediary server system, in the program database system, in association with the record data in the direct mail program database for the specific individual, the calling number of the mobile telephone number of the specific individual;
retrieving, from the program database, by the intermediary server system, based on the received code, a advertiser message on behalf of the advertiser pertinent to the specific individual, and causing the advertiser message to be delivered to the mobile telephone of the individual by the mobile telephone carrier interface; and
transmitting, by the intermediate server system, to a computer system of the specific advertiser, a sales lead message providing data including the name and mobile telephone number of the specific individual;
so that the direct mail interaction between the specific individual and the specific advertiser is efficiently transformed into an electronic relationship based directly on utilization by the specific individual of the code and the text-to phone number in an environment provided by the intermediary server system.

In a related embodiment, the record data stored in the program database system includes, for each corresponding one of the identified individuals, the text-to phone number that is in the corresponding direct mail piece, and the mobile phone data received by the intermediary server system include the text-to phone number, and retrieving the advertiser message is based additionally on the text-to phone number. Alternatively, or in addition, the sales lead message further includes the address of the specific customer. Also optionally, the advertiser is a retailer.

Also alternatively or in addition, the method includes storing, by the intermediary server system, in the program database system, in association with the record data in the direct mail program database for the specific individual, includes storing a time stamp for the time of the corresponding text message, and the sales lead message further includes the time stamp. As a further option in the foregoing embodiments, the sales lead message further includes the advertiser message.

Additionally, the method may optionally further include, before the specific piece has been printed and delivered:

defining, on behalf of the specific advertiser, a program to solicit business, including, as a part of such defining, defining the written content relating to the offering by the specific advertiser; and

preparing the direct mail program database by:
selecting, from a set of databases, records of individuals having demographic characteristics matching those of the specific advertiser for the program, the selected records corresponding to the identified individuals; and
adding to each of the selected records, the corresponding code, the corresponding text-to phone number, and a corresponding advertiser message pertinent to the individual identified by such record; and

causing the set of direct mail pieces to be printed and delivered, with each direct mail piece satisfying the foregoing conditions.

Also optionally, the computer processes further comprise:

receiving, by the intermediary server system, individual interest data from the mobile telephone of the specific individual, the individual interest data characterizing further interests of the specific individual;

storing, by the intermediary server system, in the program database system, in association with the record data in the direct mail program database for the specific individual, information, based on the individual interest data, characterizing further interests of the specific individual; and

including, by the intermediary server system, information, based on the individual interest data, characterizing further interests of the specific individual in the sales lead message.

As a further option, the data characterizing further interests of the specific individual can be a set of alphanumeric characters added by the specific individual to the code according to a further instruction provided in the written content of each direct mail piece. In that circumstance, the data characterizing further interests of the specific individual can optionally be a set of alphanumeric characters added by the specific individual as a suffix to the code according to a further instruction provided in the written content of each direct mail piece. Also optionally, the data characterizing further interests of the specific individual are provided by the specific individual in response to a text message query included in the advertiser message.

In a related set of embodiments, there is provided a non-transitory computer storage medium encoded with instructions, which, when executed on an intermediary server system coupled to a mobile telephone carrier interface, establish a computer-implemented method for transforming a direct mail interaction between a specific individual and a specific advertiser, on the basis of a specific direct mail piece, having written content relating to an offering by the specific advertiser. In this set of embodiments, the specific piece is physically delivered to the specific individual, the method utilizes computer processes that correspond those employed in any of the preceding methods.

In another embodiment, the invention provides a computer-implemented method for converting a direct marketing interaction between a specific individual and a specific advertiser, on the basis of a specific direct marketing communication, having written content relating to an offering by the specific advertiser, the specific communication delivered over a wide area network to the specific individual. The method utilizes computer processes, carried out by an intermediary server system, and the methods include:

under conditions wherein the specific direct marketing piece is one of a set of direct marketing pieces targeted and delivered over a wide area network to identified individuals as part of a direct marketing program by the specific advertiser, each direct marketing communication including in its written content (i) a code identifying a corresponding one of the identified individuals, (ii) a text-to phone number configured to receive a text message from the corresponding individual, and (iii) an instruction to the corresponding individual to manifest interest in the content by sending, to the text-to phone number, a text message that includes the code:

responsive to receipt, at a mobile telephone carrier interface, of the corresponding text message, including the code, from a mobile telephone of the specific individual:
receiving, by the intermediary server system, coupled to the mobile telephone carrier interface, mobile phone data including the code and the calling number of a mobile telephone of the specific individual, wherein the intermediary server system is coupled to a direct marketing program database system, the program database system storing record data, for each one of the identified individuals, including the specific individual, such individual's name, address, and code;
storing, by the intermediary server system, in the program database system, in association with the record data in the direct marketing program database for the specific individual, the calling number of the mobile telephone number of the specific individual;
retrieving, from the program database, by the intermediary server system, based on the received code, a advertiser message on behalf of the advertiser pertinent to the specific individual, and causing the advertiser message to be delivered to the mobile telephone of the individual by the mobile telephone carrier interface; and
transmitting, by the intermediate server system, to a server of the specific advertiser, a sales lead message providing data including the name and mobile telephone number of the specific individual;

so that the direct marketing interaction between the specific individual and the specific advertiser is efficiently converted into a multimodal relationship based directly on utilization by the specific individual of the code and the text-to phone number in an environment provided by the intermediary server system.

Embodiments summarized above and described in further detail below have the effect of transforming the nature of interaction between the individual and the advertiser from one that has existed in the physical world, typically based on the direct mail piece and visits by the individual to premises of the advertiser, to one that includes the cyberspace activity of bi-directional text messaging between the individual and the advertiser. Remarkably, the text messaging exchange is nevertheless enabled by the direct mail piece itself, in combination with an information technology infrastructure that is claimed and described herein. For these reasons, among others, the activities defined by the claims below are not well-understood, routine, or conventional to a skilled artisan in the field of the present invention.

### BRIEF DESCRIPTION OF THE DRAWINGS

The foregoing features of embodiments will be more readily understood by reference to the following detailed description, taken with reference to the accompanying drawings, in which:

FIG. 1 is a schematic rendering of a prior art direct mail piece, having content developed to benefit a specific advertiser and configured to be delivered to an individual, shown in relation to a facility of the specific retailer;

FIG. 2 is schematic diagram of the architecture of a system for transforming a direct mail interaction between an individual and an advertiser in accordance with an embodiment of the present invention;

FIG. 3 is a block diagram of computer processes carried out by the intermediary server 23 of FIG. 2 in accordance with an embodiment of a method in accordance with the present invention, and in which are also shown processes carried out by the individual in this context;

FIG. 4 is a block diagram of computer processes carried out by the intermediary server 23 of FIG. 2 in accordance with an embodiment of the invention similar to that of FIG. 3, but wherein the specific individual provides, via such individual's mobile telephone 211, individual interest data characterizing further interests of the specific individual; and

FIG. 5 is a block diagram of processes carried out in accordance with an embodiment of the present invention in defining a program, developing content of a direct mail piece, constructing a program database, and creating and delivering the corresponding direct mail pieces.

### DETAILED DESCRIPTION OF SPECIFIC EMBODIMENTS

Definitions. As used in this description and the accompanying claims, the following terms shall have the meanings indicated, unless the context otherwise requires:

A “set” has at least one member.

A “server system” includes a set of servers that may be implemented in physical hardware or may be virtualized as part of a larger hardware system.

A “computer process” is the performance of a described function in a computer using computer hardware (such as a processor, field-programmable gate array or other electronic combinatorial logic, or similar device), which may be operating under control of software or firmware or a combination of any of these or operating outside control of any of the foregoing. All or part of the described function may be performed by active or passive electronic components, such as transistors or resistors. In using the term “computer process” we do not necessarily require a schedulable entity, or operation of a computer program or a part thereof, although, in some embodiments, a computer process may be implemented by such a schedulable entity, or operation of a computer program or a part thereof. Furthermore, unless the context otherwise requires, a “process” may be implemented using more than one processor or more than one (single- or multi-processor) computer.

An “advertiser” is an individual or organization sponsoring an advertising program that utilizes a direct mail piece that is targeted to a group of individuals. An advertiser may, for example, be a retailer, an organization formed to sponsor a political candidate or a ballot initiative, or any other organization using a direct mail piece in an advertising program.

A “direct mail piece” is a printed document having content, including an address, that is customized for delivery to a specific individual, by mail or other delivery means, as part of an advertising program.

A “computer system” includes a server system, a desktop computer, a laptop computer, a tablet computer, a smartphone, or other computing device that can be coupled to the internet.

A “sales lead message” is a message to an advertiser conveying at least the phone number of a mobile phone of a specific individual who has manifested interest in content of a direct mail piece delivered to such individual by following instructions in the direct mail piece and using such mobile telephone to send, to a text-to phone number specified in the direct mail piece, a text message containing a code specified in the direct mail piece.

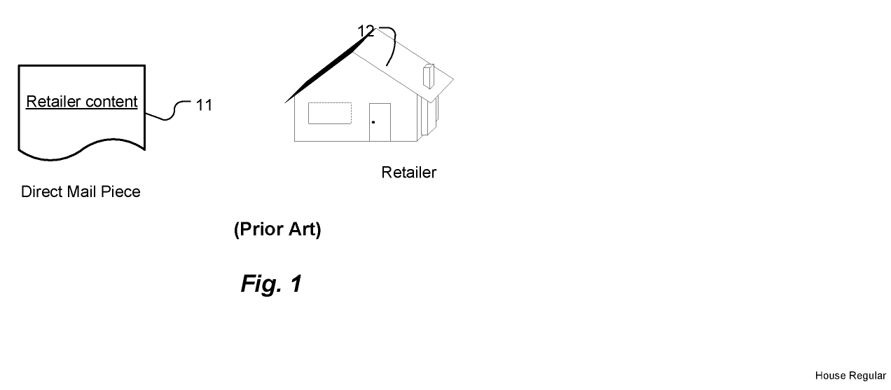

FIG. 1 is a schematic rendering of a prior art direct mail piece 11, having content developed to benefit a specific advertiser and configured to be physically delivered to an individual. In various embodiments of the present invention, the advertiser is a retailer, although in other embodiments, the advertiser may be an organization formed to sponsor a political candidate or a ballot initiative, or any other organization using a direct mail piece in an advertising program. The direct mail piece 11 is here shown in relation to a sales facility 12 of a specific retailer. In the prior art, it is known to conduct a direct-mail program by identifying demographic characteristics of individuals who constitute a target market of goods or services of the advertiser, tailoring the content of the direct-mail piece 11 to those demographic characteristics, developing a database of individuals in the advertiser's market area who have such demographic characteristics, and causing physical delivery of the direct-mail piece 11 to the individuals in the database. Although the direct-mail piece 11 is targeted to individuals of a given demographic profile, the advertiser will have no explicit way of identifying individuals who have been motivated specifically by the direct-mail piece 11 to patronize the facility 12 of the advertiser, nor in general will the advertiser be able to correlate effort in the direct-mail program (leading to creation and distribution of the direct-mail piece 11) with any particular success of the advertiser.

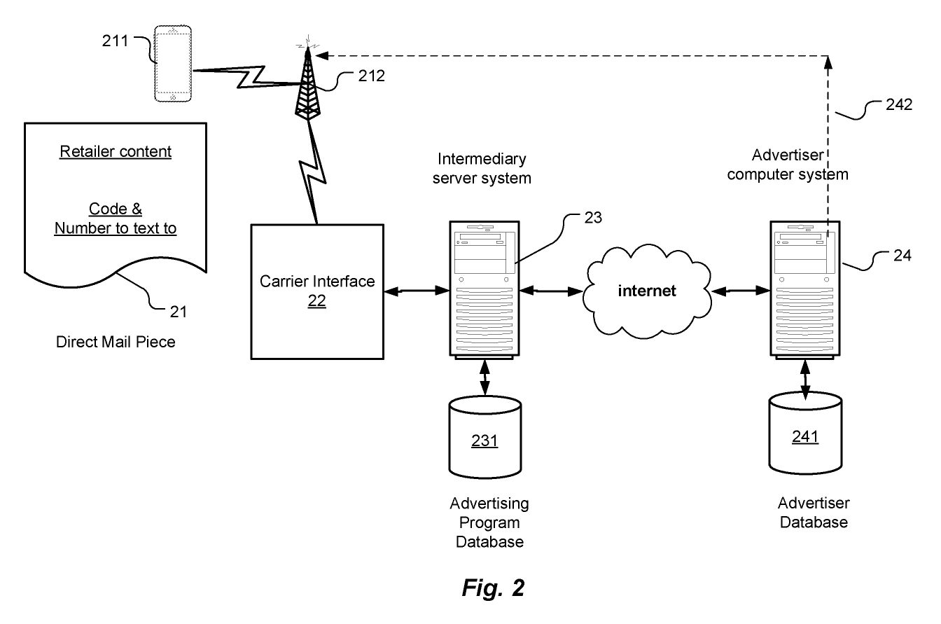

As described in detail in connection with FIG. 2 and figures thereafter, embodiments of the present invention transform the prior art relationship described in connection with FIG. 1 into a new kind of relationship in which the individual's relation to the advertiser is mediated by an intermediary's server system. In the environment of the intermediary server system, the advertiser is provided with information allowing a direct correlation between an individual contacting the advertiser and the specific direct-mail piece giving rise to the contact.

FIG. 2 is a schematic diagram of the architecture of a system for transforming a direct mail interaction between an individual and an advertiser in accordance with an embodiment of the present invention. Although the direct-mail piece 21 of FIG. 2 has advertiser content similar to that of the direct-mail piece 11 of FIG. 1, the direct-mail piece 21, addressed to a specific individual, also includes, in its content, (i) a code identifying the specific individual, (ii) a text-to phone number configured to receive a text message from the specific individual, and (iii) an instruction to the specific individual to manifest interest in the content by sending, to the text-to phone number, a text message that includes the code. A motivated individual, in receipt of the direct-mail piece 21, would follow the instruction, using the individual's mobile phone 211, to send a text message, wherein the text message includes the code, to the designated text-to phone number. In this context, the text-to phone number is assigned to a carrier interface 22 associated with the intermediate server system 23. (In various embodiments of the present invention, the text-to phone number is a “short code,” used for commercial text messaging purposes, that is available from carriers for this purpose.) When the specific individual uses his mobile phone 211 to send the code to the text-to phone number, the mobile carrier 212 receives the text message and sends it to the destination text-to number at the carrier interface 22. The intermediary server system 23 is coupled to the carrier interface 22, which, in turn, is coupled to any of a set of mobile telephone networks and is configured to receive text messages over the mobile telephone networks. The carrier interface can be implemented as a direct hardware interface, or, alternatively, can be implemented via procedural calls to a cloud-based contact center service such as Bandwidth.com of Raleigh, N.C. (web site at https://www.bandwidth.com/) or Nexmo of San Francisco, Calif. (website at https://www.nexmo.com/), or Plivo of San Francisco, Calif. (website at http://www.plivo.com/). The carrier interface 22 receives the text message from the specific individual's mobile phone 211 and provides data related to the text message including the code, the text-to phone number, and the number of the specific individual's mobile phone. These data are associated with and stored in an updated record of the specific individual in a program database 231, which is coupled to the intermediary server system 23. Information stored in the updated program database 231 can then be communicated, over a network such as the internet, by the intermediary server system 23 to a computer system 24 of the advertiser, where the information can be stored in the advertiser database 241. Because the advertiser now has contact information for the specific individual, including the individual's mobile telephone number, the advertiser, via server 24 over path 242, can communicate with the specific individual's mobile phone 211, although other communication options are also possible, for example by a direct call from an agent of the advertiser to the specific individual's mobile phone 211.

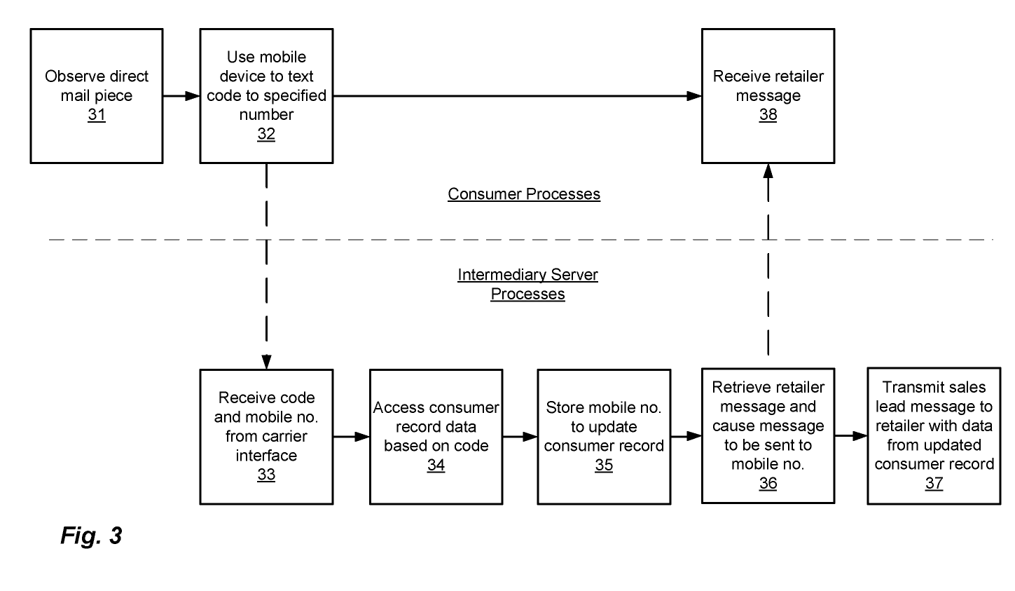

FIG. 3 is a block diagram of computer processes carried out by the intermediary server 23 of FIG. 2 in accordance with an embodiment of a method in accordance with the present invention, and in which are also shown processes 31, 32, and 38 carried out by the individual in this context. In process 31, the individual observes direct-mail piece 21, and following instructions in the direct-mail piece uses the mobile device 211 to send a text message, containing the code, to the text-to phone number. As previously described, the text-to phone number is associated with the carrier interface 22, which, in process 33, receives the text message and passes data associated with the received text message to the intermediary server system 23. Because the code in the received text message is associated with the specific individual, the intermediary server system 23, in process 34, uses the code to access the record of the specific individual in the program database 231, which is coupled to the intermediary server. In turn, in process 35, the intermediary server 23 stores data associated with the received text message in association with the record in the program database 231 for the specific individual. In process 36, the intermediary server 23 retrieves, from the record in the program database 231 for the specific individual, an advertiser message that has been tailored to the specific individual and, through the carrier interface 22, causes the advertiser message to be sent to the mobile phone 211 of the specific individual. Optionally, the advertiser message is prepared and transmitted as a multimedia text message, which may include pictorial or graphic content and/or a link to any desired content, including video content, and indeed to any website on the World Wide Web. In process 38, the advertiser message is received on the mobile phone 211 of the specific individual. In process 37, the intermediary server system 23 retrieves data from the record in the program database 231 for the specific individual and uses these retrieved data to form a sales lead message, including the phone number of the mobile phone 211 of the specific individual, and transmits the sales lead message to a computer system of the advertiser. In a further related embodiment, the sales lead message to the advertiser additionally includes the specific individual's name and address, the advertiser message, and the date and time of receipt of the text message from the specific individual.

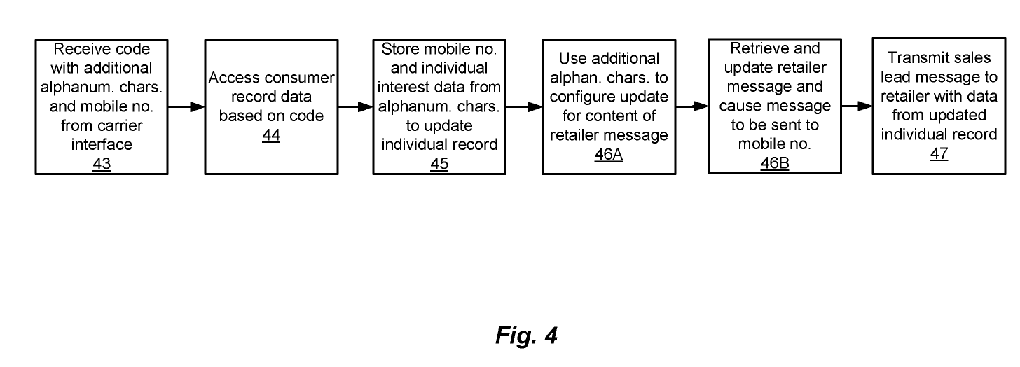

FIG. 4 is a block diagram of computer processes carried out by the intermediary server 23 of FIG. 2 in accordance with an embodiment of the invention similar to that of FIG. 3, but wherein the specific individual provides, via such individual's mobile telephone 211, individual interest data characterizing further interests of the specific individual, to which the advertiser's response can be further customized. In this embodiment, in process 43, as in process 33, the intermediary server system 23 receives the text message sent by the specific individual via mobile phone 211 to the text-to number containing the code specified in the direct mail piece 21. Additionally, however, the specific individual provides individual interest data characterizing further interests of the specific individual. In one related aspect of this embodiment, the specific individual is provided, in the direct mail piece 21, with a list of potential further interests, in which each potential further interest is designated by a corresponding set of alphanumeric characters.

In the direct mail piece 21, the individual is provided with an instruction to add the set of characters, such as appear in Table 1, corresponding to the individual's further interest, as a suffix to the code being sent as a text message. Accordingly, in process 43, the intermediary server system receives, from the carrier interface 22, not only the code and the number of the specific individual's mobile phone 211, but also the corresponding set of alphanumeric characters that were added as a suffix by the specific individual. In process 44 (in a manner similar to that described in connection with process 34 of FIG. 3), the intermediary server system 23 uses the code to access the record of the specific individual in the program database 231, which is coupled to the intermediary server 23. In turn, in process 45, the intermediary server system 23 stores information corresponding to the received data (including the mobile number and the received set of alphanumeric characters identifying the specific individual's further interest) in association with the record in the program database 231 for the specific individual. In process 46A, the intermediary server system 23 uses the data characterizing the specific individual's further interest to configure an update for the content of the advertiser message. In process 46B, the intermediary server system 23 retrieves and tailors the advertiser message to conform to the specific individual's designated further interest. Finally, in process 47, the intermediary server system 23 retrieves data from the record in the program database 231 for the specific individual and uses these retrieved data to form a sales lead message, including, among other things, the phone number of the mobile phone 211 of the specific individual and the specific individual's designated further interest, and transmits the sales lead message to the advertiser. The sales lead message is transmitted to a computer system of the advertiser, which may be a server system, a desktop computer, or a smartphone, or combinations of these computer systems.

In one embodiment, for example, the advertiser is a car dealer, the direct mail piece data might instruct the individual thus:

TEXT your Code to ANTPR and Indicate your New Vehicle Interest:

| Select New Nissan | TEXT this code to |
|---|---|
| Model of Interest | ANTPR |
| Altima | PMENGV12 |
| Maxima | PMENGV23 |
| Rogue | PMENGV45 |
| Sentra | PMENGV67 |
| Versa | PMENGV89 |

Thus, if the specific individual's further interest is a new Nissan Sentra, the individual would add 12 as a suffix to the code being sent as a text message, so the entire string sent as a text message would be “PMENGV12.”

In another embodiment, for example, the advertiser is an organization formed on behalf of a political candidate, and the direct mail piece, in asking the individual to respond by texting to a specified number, includes a way for the individual to indicate specific interests. The direct mail piece might include the following text:

Please Indicate Which of these Issues is Most Important to You:

| Issue | TEXT |
|---|---|
| Gun control | ABCDEF11 |
| Immigration | ABCDEF22 |
| Conflicts with other countries | ABCDEF33 |
| Budget with increasing deficits | ABCDEF44 |

In this example, if the individual texts ABCDEF44, the interest in the Budget deficit is provided in the sales lead message, and the advertiser message is customized, based on this interest data, to include content such as: “Jane, thank you for your feedback. Continuing to add more dollars to deficit spending is a big concern of mine as well. Please join me at my rally in Boston on July 13^{th}. I'd like to meet you and hear your ideas for how we can get spending under control. In the meantime, please visit my website at www.tomsmithforcongress.com.”

In a further related embodiment of the present invention, as an alternative to using the set of alphanumeric characters by which the specific individual may characterize further interest, the advertiser message transmitted to the mobile phone of the individual as a text message or multimedia message can itself include a query to the individual by which the individual can respond. In various aspects if this embodiment, the intermediary server system can be structured so that the individual's response to the query is a text message or, alternatively, structured so that the response can be entered on a website accessed by a link provided in the advertiser message.

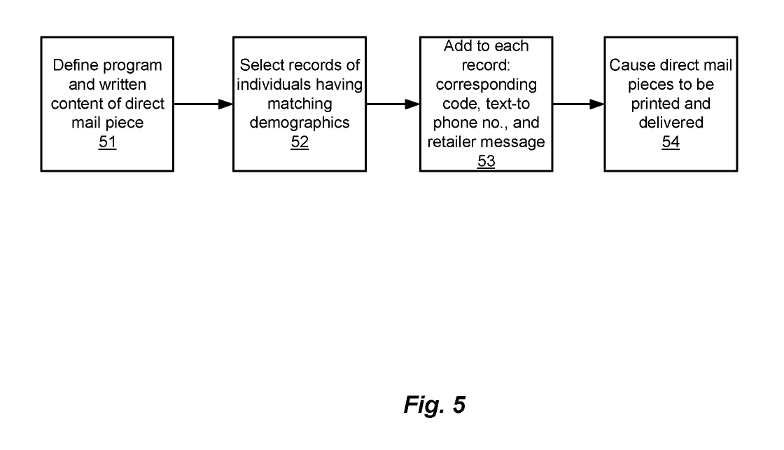

FIG. 5 is a block diagram of processes carried out in accordance with an embodiment of the present invention in defining a program to solicit business on behalf of the advertiser, developing content of a direct mail piece, constructing a program database, and creating and delivering the corresponding direct mail pieces. In process 51, there is defined a direct-mail program that includes the written content of the direct-mail piece 21 to be used in the program on behalf of the specific advertiser. In process 52, in conjunction with the work in process 51, records of individuals having demographic characteristics matching those of the specific advertiser for the program are selected from a set of databases. In process 53, to each of these selected records are added the code, the text-to phone number, and the tailored advertiser message for each individual, so as to form the program database 231.

As an example, the specific advertiser may be a new car dealer. The offering by the advertiser may be made by a direct mail piece to identified individuals as a part of a direct mail program. Under terms of the offering, the direct mail piece, corresponding to item 21 of FIG. 2, delivered to each individual, invites the individual to learn how much the advertiser would give to the individual for such individual's vehicle when used as a trade-in for purchase of a new car from the advertiser. In order for the individual to learn this value, the specific individual is instructed by the direct mail piece, for example, to send the code “49782” to the text-to number “256-294-4706”. In this case code “49782” would identify the specific individual, and intermediary server would use the code in process 34 to identify the specific individual by accessing the record data in the program database 231. The program database, in turn, would be typically assembled by culling from the advertiser's database of past customers and supplementing this listing with additional listings from one or more third-party databases of individuals meeting desired demographic criteria established on behalf of the advertiser, such as, for example:
a. living within a 10-mile radius of the retailer's location;
b. having children ranging in age from 14 to 18 years old;
c. having an annual household income of $45,000-$75,000;
d. having a credit score greater than 580 but less than 700;
e. owning a home but having a mortgage which is greater than 3 years old, and an outstanding balance of between $100,000 and $250,000; and
f. owning a vehicle older than 2 years, but less than 5 years old.

The program database is constructed to include, per FIG. 5, in a distinct record, for each individual, the individual's name and address, and the code that will uniquely identify the individual to the intermediary server system. In various embodiments the program database will also include in each record the text-to number to identify the particular program to the intermediary server system. Additionally, for each individual, the record will include the retailer message concerning the individual's vehicle and the estimated trade-in value the retailer will give to the vehicle. After the program database has been assembled, the direct mail pieces can be printed and delivered to the identified individuals, and the processes described above in connection with FIGS. 2-4 can be implemented.

Another class of embodiments of the present invention is pertinent to a direct marketing interaction that involves, instead of a direct mail program as described above, a set of direct marketing communications delivered over a wide area network and having written content relating to an offering by a specific advertiser. This class of embodiments provides a computer-implemented method for converting a direct marketing interaction between a specific individual and the specific advertiser, on the basis of the specific direct marketing communication delivered over a wide area network to the specific individual, The method and apparatus of this class of embodiments are similar to the method and apparatus described above in connection with FIGS. 2-5 above.

Instead of the direct mail piece 21 of FIG. 2, however, this class of embodiments utilizes a direct marketing communication that is delivered electronically over a wide area network instead of delivered physically as the direct mail piece 21. In one embodiment, the direct marketing communication substituting for the direct mail piece 21 is an email or instant message directed to the specific individual. In another embodiment, the direct marketing communication is a web page linked in the email or the instant message directed to the specific individual. The instant message may be directed to the specific individual by a social network, such as provided by Facebook, available at Facebook.com, or by another service providing instant messaging.

Although, as just described, the direct marketing communication has a manner of delivery that differs from the manner of delivery of the direct mail piece 21, the content of the direct marketing communication is similar to the content of the direct mail piece 21. In particular, the direct marketing communication, like the direct mail piece 21, includes, in its content, (i) a code identifying the specific individual, (ii) a text-to phone number configured to receive a text message from the specific individual, and (iii) an instruction to the specific individual to manifest interest in the content by sending, to the text-to phone number, a text message that includes the code. Once the specific individual receives the direct marketing communication, the operation of this class of embodiments is substantially similar to the operation as described above in connection with FIGS. 2-5. In this connection, in a manner analogous to the situation in FIG. 2, a motivated individual, in receipt of the direct marketing communication, would follow the instruction in the direct marketing communication, using the individual's mobile phone 211, to send a text message, wherein the text message includes the code, to the designated text-to phone number. There then ensue processes similar to those as described previously in the context of the direct mail piece 21.

The embodiments of the invention described above are intended to be merely exemplary; numerous variations and modifications will be apparent to those skilled in the art. All such variations and modifications are intended to be within the scope of the present invention as defined in any appended claims.

1. A computer-implemented method for transforming a direct mail interaction between a specific individual and a specific advertiser, on the basis of a specific direct mail piece, having written content relating to an offering by the specific advertiser, the specific piece physically delivered to the specific individual, the method utilizing computer processes, carried out by an intermediary server system, comprising:
under conditions wherein the specific direct mail piece is one of a set of direct mail pieces targeted and physically delivered to identified individuals as part of a direct mail program by the specific advertiser, each direct mail piece including in its written content (i) a code identifying a corresponding one of the identified individuals, (ii) a text-to phone number configured to receive a text message from the corresponding individual, and (iii) an instruction to the corresponding individual to manifest interest in the content by sending, to the text-to phone number, a text message that includes the code:
responsive to receipt, at a mobile telephone carrier interface, of the corresponding text message, including the code, from a mobile telephone of the specific individual, such mobile telephone having a telephone number:
receiving, by the intermediary server system, coupled to the mobile telephone carrier interface, mobile phone data including the code and the telephone number of the mobile telephone of the specific individual, wherein the intermediary server system is coupled to a direct mail program database system, the program database system storing record data, for each one of the identified individuals, including the specific individual, such individual's name, address, and code;
storing, by the intermediary server system, in the program database system, in association with the record data in the direct mail program database system for the specific individual, the telephone number of the mobile telephone number of the specific individual;
retrieving, from the program database, by the intermediary server system, based on the received code, an advertiser message on behalf of the advertiser pertinent to the specific individual, and causing the advertiser message to be delivered to the mobile telephone of the specific individual by the mobile telephone carrier interface; and
transmitting, by the intermediate server system, to a computer system of the specific advertiser, a sales lead message providing data including the name and mobile telephone number of the specific individual;
so that the direct mail interaction between the specific individual and the specific advertiser is transformed into an electronic relationship based directly on utilization by the specific individual of the code and the text-to phone number in an environment provided by the intermediary server system.

2. A computer-implemented method according to claim 1, wherein the record data stored in the program database system includes, for each corresponding one of the identified individuals, the text-to phone number that is in the corresponding direct mail piece, and the mobile phone data received by the intermediary server system include the text-to phone number, and retrieving the advertiser message is based additionally on the text-to phone number.

3. A computer-implemented method according to claim 1, wherein the sales lead message further includes the address of the specific customer.

4. A computer-implemented method according to claim 1, wherein the advertiser is a retailer.

5. A computer-implemented method according to claim 1, wherein storing, by the intermediary server system, in the program database system, in association with the record data in the direct mail program database for the specific individual, includes storing a time stamp for the time of the corresponding text message, and the sales lead message further includes the time stamp.

6. A computer-implemented method according to claim 1, wherein the sales lead message further includes the advertiser message.

7. A computer-implemented method according to claim 1, further comprising, before the specific piece has been printed and delivered:
defining, on behalf of the specific advertiser, a program to solicit business, including, as a part of such defining, defining the written content relating to the offering by the specific advertiser; and
preparing the direct mail program database by:
selecting, from a set of databases, records of individuals having demographic characteristics matching those of the specific advertiser for the program, the selected records corresponding to the identified individuals; and
adding to each of the selected records, the corresponding code, the corresponding text-to phone number, and a corresponding advertiser message pertinent to the individual identified by such record; and
causing the set of direct mail pieces to be printed and delivered, with each direct mail piece satisfying the foregoing conditions.

8. A method according to claim 1, wherein the computer processes further comprise:
receiving, by the intermediary server system, individual interest data from the mobile telephone of the specific individual, the individual interest data characterizing further interests of the specific individual;
storing, by the intermediary server system, in the program database system, in association with the record data in the direct mail program database for the specific individual, information, based on the individual interest data, characterizing further interests of the specific individual; and
including, by the intermediary server system, information, based on the individual interest data, characterizing further interests of the specific individual in the sales lead message.

9. A method according to claim 8, wherein the data characterizing further interests of the specific individual are a set of alphanumeric characters added by the specific individual to the code according to a further instruction provided in the written content of each direct mail piece.

10. A method according to claim 9, wherein the data characterizing further interests of the specific individual are a set of alphanumeric characters added by the specific individual as a suffix to the code according to a further instruction provided in the written content of each direct mail piece.

11. A method according to claim 8, wherein the data characterizing further interests of the specific individual are provided by the specific individual in response to a text message query included in the advertiser message.

12. A non-transitory computer storage medium encoded with instructions, which, when executed on an intermediary server system coupled to a mobile telephone carrier interface, establish a computer-implemented method for transforming a direct mail interaction between a specific individual and a specific advertiser, on the basis of a specific direct mail piece, having written content relating to an offering by the specific advertiser, the specific piece physically delivered to the specific individual, the method utilizing computer processes comprising:
under conditions wherein the specific direct mail piece is one of a set of direct mail pieces targeted and physically delivered to identified individuals as part of a direct mail program by the specific advertiser, each direct mail piece including in its written content (i) a code identifying a corresponding one of the identified individuals, (ii) a text-to phone number configured to receive a text message from the corresponding individual, and (iii) an instruction to the corresponding individual to manifest interest in the content by sending, to the text-to phone number, a text message that includes the code:
responsive to receipt, at the mobile telephone carrier interface, of the corresponding text message, including the code, from a mobile telephone of the specific individual, such mobile telephone having a telephone number:
receiving, by the intermediary server system, coupled to the mobile telephone carrier interface, mobile phone data including the code and the telephone number of the mobile telephone of the specific individual, wherein the intermediary server system is coupled to a direct mail program database system, the program database system storing record data, for each one of the identified individuals, including the specific individual, such individual's name, address, and code;
storing, by the intermediary server system, in the program database system, in association with the record data in the direct mail program database system for the specific individual, the telephone number of the mobile telephone number of the specific individual;
retrieving, from the program database, by the intermediary server system, based on the received code, an advertiser message on behalf of the advertiser pertinent to the specific individual, and causing the advertiser message to be delivered to the mobile telephone of the individual by the mobile telephone carrier interface; and
transmitting, by the intermediate server system, to a server of the specific advertiser, a sales lead message providing data including the name and mobile telephone number of the specific individual;
so that the direct mail interaction between the specific individual and the specific advertiser is transformed into an electronic relationship based directly on utilization by the specific individual of the code and the text-to phone number in an environment provided by the intermediary server system.

13. A non-transitory computer storage medium encoded with instructions according to claim 12, wherein the record data stored in the program database system includes, for each corresponding one of the identified individuals, the text-to phone number that is in the corresponding direct mail piece, and the mobile phone data received by the intermediary server system include the text-to phone number, and retrieving the advertiser message is based additionally on the text-to phone number.

14. A non-transitory computer storage medium encoded with instructions according to claim 12, wherein the sales lead message further includes the address of the specific customer.

15. A non-transitory computer storage medium encoded with instructions according to claim 12, wherein the advertiser is a retailer.

16. A non-transitory computer storage medium encoded with instructions according to claim 12, wherein storing, by the intermediary server system, in the program database system, in association with the record data in the direct mail program database for the specific individual, includes storing a time stamp for the time of the corresponding text message, and the sales lead message further includes the time stamp.

17. A non-transitory computer storage medium encoded with instructions according to claim 12, wherein the sales lead message further includes the advertiser message.
receiving, by the intermediary server system, individual interest data from the mobile telephone of the specific individual, the individual interest data characterizing further interests of the specific individual;
storing, by the intermediary server system, in the program database system, in association with the record data in the direct mail program database for the specific individual, information, based on the individual interest data, characterizing further interests of the specific individual; and
including, by the intermediary server system, information, based on the individual interest data, characterizing further interests of the specific individual in the sales lead message.

18. A non-transitory computer storage medium encoded with instructions according to claim 12, the computer processes further comprising:
receiving, by the intermediary server system, individual interest data from the mobile telephone of the specific individual, the individual interest data characterizing further interests of the specific individual;
storing, by the intermediary server system, in the program database system, in association with the record data in the direct mail program database for the specific individual, information, based on the individual interest data, characterizing further interests of the specific individual; and
including, by the intermediary server system, information, based on the individual interest data, characterizing further interests of the specific individual in the sales lead message.

19. A non-transitory computer storage medium encoded with instructions according to claim 12, wherein the data characterizing further interests of the specific individual are a set of alphanumeric characters added by the specific individual to the code according to a further instruction provided in the written content of each direct mail piece.

20. A computer-implemented method for converting a direct marketing interaction between a specific individual and a specific advertiser, on the basis of a specific direct marketing communication, having written content relating to an offering by the specific advertiser, the specific communication delivered over a wide area network to the specific individual, the method utilizing computer processes, carried out by an intermediary server system, comprising:
under conditions wherein the specific direct marketing piece is one of a set of direct marketing pieces targeted and delivered over a wide area network to identified individuals as part of a direct marketing program by the specific advertiser, each direct marketing communication including in its written content (i) a code identifying a corresponding one of the identified individuals, (ii) a text-to phone number configured to receive a text message from the corresponding individual, and (iii) an instruction to the corresponding individual to manifest interest in the content by sending, to the text-to phone number, a text message that includes the code:
responsive to receipt, at a mobile telephone carrier interface, of the corresponding text message, including the code, from a mobile telephone of the specific individual, such mobile telephone having a telephone number:
receiving, by the intermediary server system, coupled to the mobile telephone carrier interface, mobile phone data including the code and the telephone number of the mobile telephone of the specific individual, wherein the intermediary server system is coupled to a direct marketing program database system, the program database system storing record data, for each one of the identified individuals, including the specific individual, such individual's name, address, and code;
storing, by the intermediary server system, in the program database system, in association with the record data in the direct marketing program database for the specific individual, the telephone number of the mobile telephone number of the specific individual;
retrieving, from the program database, by the intermediary server system, based on the received code, an advertiser message on behalf of the advertiser pertinent to the specific individual, and causing the advertiser message to be delivered to the mobile telephone of the individual by the mobile telephone carrier interface; and
transmitting, by the intermediate server system, to a server of the specific advertiser, a sales lead message providing data including the name and mobile telephone number of the specific individual;
so that the direct marketing interaction between the specific individual and the specific advertiser is converted into a multimodal relationship based directly on utilization by the specific individual of the code and the text-to phone number in an environment provided by the intermediary server system.
